(19) United States
(12) Patent Application Publication
(10) Pub. No.: US 2007/0262090 A1
(43) Pub. Date: Nov. 15, 2007

(54) Metering Device

(76) Inventor: Stefan Ritsche, Eigeltingen (DE)

Correspondence Address: FLYNN THIEL BOUTELL & TANIS, P.C., 2026 RAMBLING ROAD, KALAMAZOO, MI, 49008-1631, US

(21) Appl. No.: 11/665,129

(22) PCT Filed: Oct. 13, 2005
(86) PCT No.: PCT/EP05/10994

§ 371 Date: Apr. 11, 2007

(30) Foreign Application Priority Data
Oct. 13, 2004 (DE) 10 2004 050 679.5

(51) Int. Cl. B67D 5/58; B65D 83/00; B65D 88/54

(52) U.S. Cl. 222/189.09; 222/321.6

(57) ABSTRACT

The invention relates to a known metering device (1) for at least one medium. Said device comprises a pump unit (2), which co-operates with a medium reservoir for the delivery of said medium and an aeration device that is allocated to the medium reservoir and/or the pump unit. The aeration device comprises an aeration channel (16, 18, 26, 27), to which a filter membrane (20) is allocated. According to the invention, the filter membrane is configured for a reduced diffusion rate. The device can be used for metering pharmaceutical products.

The invention relates to a metering device for at least one medium, with a pump unit, which is operatively connected to a medium reservoir for the purpose of discharging a medium, and with a venting device, which is assigned to the medium reservoir and/or to the pump unit and which has a venting channel to which a filter membrane is assigned.

A metering device comprising a venting device is known from EP 1 295 644 A1. The metering device is used for discharging a medium from a medium reservoir by means of a pump unit in several dispensing strokes that are separated from one another in time or that immediately succeed one another. For this purpose, the pump unit is operatively connected to the medium reservoir, allowing it to discharge medium from the medium reservoir into the environment of the metering device. The venting device according to EP 1 295 644 A1 comprises a venting channel to which a filter unit is assigned that acts as a barrier against contaminating constituents of the outside air, preventing them from reaching the medium enclosed in the medium reservoir. Such a filter unit is intended to dispense with the need for agents for preserving the medium, because the air entering the medium reservoir during pressure equalization between environment and medium reservoir is intended to be kept free from contaminating constituents by the filter unit. This is of great importance particularly in the case of medical substances. A constant exchange of gas molecules between the environment and the medium enclosed in the medium container is possible through the filter unit, such that the desired pressure equalization can take place, while escape of the medium into the venting device and penetration of contaminating substances into the medium reservoir are prevented by the filter unit.

The object of the invention is to make available a metering device which ensures an improved long-term stability of the enclosed medium and a high degree of metering precision in respect of the active substance concentration in the medium that is to be dispensed.

This object is achieved by means of a metering device of the type mentioned at the outset in which the filter membrane is configured for a reduced diffusion rate. This means that, compared to known metering devices, there is a reduced exchange of gas molecules between the volume enclosed in the medium reservoir and the environment. The diffusion rate is defined on the basis of the volumetric flow of gas molecules that takes place through the filter membrane within a time interval at a given pressure ratio between the internal pressure in the medium reservoir and the external pressure in the environment. A low diffusion rate means that, if there is a high pressure difference between the internal pressure in the medium reservoir and the external pressure prevailing in the environment, only a small volumetric flow of gas molecules passes through the filter membrane. In a filter membrane having a reduced diffusion rate, evaporated constituents of the medium can escape less easily from the medium container and, if there is an underpressure in the medium reservoir, air molecules from the environment can less easily enter the medium reservoir. An improvement in the long-term stability of the medium enclosed in the medium container is achieved, on the one hand, by a smaller loss of readily releasable constituents of the medium, which could otherwise escape as readily volatile constituents from the medium reservoir. Because of the reduced diffusion rate of the filter membrane, the evaporated, readily releasable constituents of the medium are retained in the medium reservoir for a longer period of time and also at a higher pressure difference between internal pressure and external pressure. In this way, a change in the concentration of the medium can be largely avoided or at least reduced. On the other hand, the reduced diffusion rate means a delayed inflow of air from the environment in the event of an underpressure in the medium reservoir. This has the effect that, when an underpressure develops in the medium reservoir after a discharge procedure, for example, gas constituents initially dissolved in the medium pass into the gaseous phase and thus cause the underpressure to decrease before air from the environment flows in. Therefore, a filter membrane with a reduced diffusion rate can, over a long period of time, avoid a change in the concentration of the medium or can at least largely suppress such a change. This influence of the filter membrane on the enclosed medium is an important criterion in assessing the suitability of a metering device for storing and dispensing medical substances. A change in concentration poses the danger that the medium to be dispensed by the metering device contains an increasing quantity of active substance while the volume dispensed remains constant, such that possible demands in respect of the precise metering of the active substance may no longer be satisfied, even when the dispensed volume of medium remains exactly the same. To determine such behavior of the metering device and of the medium received in it, stability tests are carried out on the metering device, particularly in the case of media that are used as medical active substances and for which precise metering is necessary. In these tests, the change in the concentration of the medium (dose content uniformity) is evaluated over quite a long period of time and under changing climatic external conditions and is assessed on the basis of predetermined limit values. One simple stability test seeks to ascertain to what extent the weight of the metering device decreases over a period of time. Starting out from the original concentration of active substance, it is then possible to draw conclusions regarding a change in the concentration of the active substance in the medium. The reduced diffusion rate ensures that, on the one hand, the pressure equalization necessary for correct dispensing of medium can take place and, on the other hand, the long-term stability of the enclosed medium is ensured. This solution is suitable in particular for the metering of pharmaceutical products. Possible media are liquid and solid substances, and mixtures thereof, that can be administered in particular as medicaments. Depending on the medium that is to be dispensed, greater or lesser demands are placed on the metering of the quantity of medium to be dispensed by the pump unit and on the concentration of medically active ingredients contained therein. The pump unit can be designed, for example, for atomized dispensing of medium or for individual jets of the medium. The venting device provided on the metering device serves for pressure equalization between an internal pressure of a volume enclosed in the medium reservoir and an external pressure prevailing in the environment of the medium reservoir. A pressure difference can arise as a result of the discharge of medium from the medium reservoir or also as a result of thermally induced expansion or shrinking phenomena of the medium or media contained in the medium reservoir. However, in metering devices of this kind, pressure differences are generally undesirable, because they have a negative impact on the precision of the metering of the medium that is to be dispensed. Therefore, a pressure equalization between the internal pressure and the external pressure is permitted by means of the venting device, with gas from the environment being able to flow into the medium reservoir, and gaseous or possibly also liquid or solid constituents of the medium being able to escape from the medium reservoir. This therefore ensures the pressure equalization and, consequently, the desired high-precision metering of the metering device in respect of the volume of medium that is to be dispensed.

In one embodiment of the invention, the filter membrane has a reduced effective cross section compared to known filter membranes. The effective cross section is the product of the number of pores provided in the filter membrane and the mean free cross section of these pores. Filter membranes are designed in particular as stretched or perforated plastic films or as sinter materials, but also as metal foils, and, depending on the chosen production method, they can vary within a wide range in terms of the number of pores and the free cross sections of the pores. The pores or channels formed in the plastic film or in the sinter material in each case have a free cross section that can be determined on the basis of the maximum molecule size that is able to pass through the channel. The effective cross section is in direct relation to the diffusion rate of the filter membrane. A large number of channels or pores and a large free cross section of the individual channels or pores results in a large effective cross section and permits a high diffusion rate, i.e. a large number of molecules can pass through the filter membrane even at a low pressure difference. According to the invention, the effective cross section is reduced by comparison with known filter membranes, i.e. the product of the number of pores and mean free cross section of the pores is smaller than in conventional membranes.

In another embodiment of the invention, the reduced effective cross section of the filter membrane is achieved by a reduced effective surface area compared to known filter membranes. A reduction in the effective cross section is achieved particularly advantageously in this way. The effective surface area of the filter membrane is that surface area of the membrane that is permeated with pores and that is available for passage of gas molecules. The pores defining the effective cross section of the filter membrane are arranged on the effective surface area.

In another embodiment of the invention, the effective surface area of the filter membrane is limited by a flow-guide geometry which, at least in some sections, has a conical design. In a given filter membrane, which for example has a substantially constant number of pores per surface area across its entire surface, it is thus possible, in a particularly advantageous manner, to influence the effective surface area and, consequently, the effective cross section. The flow-guide geometry on the one hand closes the excess pores that are not intended to be available for passage of gas molecules, and, on the other hand, it ensures that the gas stream passing through the filter membrane is focused on the predetermined area of the filter membrane. In addition, the flow-guide geometry can be used to hold and stabilize the filter membrane mechanically, in particular with a form fit. By having a conical configuration at least in some sections, the flow-guide geometry can permit particularly advantageous flow of gas molecules to and from the filter membrane, because the conical contour allows the gas stream to be guided substantially without swirling.

In another embodiment of the invention, the effective surface area of the filter membrane is smaller than 1.4 mm², preferably smaller than 0.6 mm², particularly preferably smaller than 0.2 mm². Compared to a known filter membrane, this reduces the effective surface area and the associated diffusion rate by at least ca. 15%, preferably by ca. 60%, particularly preferably by ca. 85%.

In another embodiment of the invention, in order to obtain the reduced effective cross section, a mean free cross section of pores in the filter membrane is designed smaller than in known filter membranes. This means that the size of the gas molecules that are able to pass through the filter membrane is reduced. Escape of evaporated constituents of the medium from the medium reservoir is made difficult by this, and the diffusion rate is likewise reduced, because not all the gas molecules present in the ambient air can pass through the filter membrane.

In another embodiment of the invention, in order to obtain a reduced effective cross section, a reduced number of pores is provided compared to known filter membranes. The product of free pore cross section and number of pores is thus reduced in a simple manner, and the desired reduction in the diffusion rate is thereby achieved. Depending on the method used for producing the filter membrane, a reduction in the number of pores is achieved in particular by introducing a small number of pores by means of a material-removing method for a plastic film, or by selecting a larger particle size in conjunction with a sintering process at high pressure and/or high temperature for a sinter material.

In another embodiment of the invention, the filter membrane has a mean pore number of less than 1 million pores per mm², preferably of less than 600,000 pores per mm², particularly preferably of less than 300,000 pores per mm. The number of pores can be influenced in a simple way, for example in a material-removing method, in which the pores are introduced into a plastic film by means of high-energy electromagnetic radiation.

In another embodiment of the invention, the filter membrane is provided on a sealing unit arranged in the venting channel, in particular between the medium container and the pump unit. In this way, the filter membrane can easily be integrated into the venting device and does not require a separate support for stabilizing and/or positioning. For a leaktight connection between the medium reservoir and the pump unit, known metering devices have a sealing unit, which can be designed, for example, as an annular flat seal. On this flat seal, the filter membrane can be applied, in particular laminated, partially or completely onto at least one end face directed toward the medium reservoir or the pump unit. This permits an advantageous separate production of the sealing unit with applied filter membrane. The assembling of the sealing unit can take place in the same way as in known metering devices and involves at the same time the positioning of the filter membrane.

In another embodiment of the invention, the filter membrane is designed to close a through-opening provided in the sealing unit and assigned to the venting channel. A through-opening provided in the sealing unit, and assigned to the venting channel, exactly defines a cross section through which gas molecules can flow from the medium reservoir to the environment or in the reverse direction into the medium reservoir. This passage cross section is closed by the filter membrane, such that it is possible to exactly predetermine a diffusion rate that arises from the passage cross section and from the associated effective surface area of the filter membrane and from the resulting effective cross section of the filter membrane.

In another embodiment of the invention, the filter membrane is applied, in particular laminated on, in the area of a venting opening of the medium reservoir and/or of the pump unit. In this way, the filter membrane can already be applied during the production of the medium reservoir and is supported by a wall section of the medium reservoir, resulting in a particularly compact configuration of the filter unit. The filter membrane is preferably applied, in particular welded or laminated, onto an end face or outer surface of a section of the medium reservoir or of part of the pump unit.

In another embodiment of the invention, the filter unit is designed as a discrete filter cartridge. In this way, the filter unit can be produced, and if appropriate tested, independently of the pump unit and of the medium dispenser. In addition, the filter unit can be provided as a mass-produced article for a large number of different metering devices.

The object of the invention is also achieved by a metering device of the type mentioned at the outset in which the venting channel is designed at least in some parts as a capillary channel which, at least in some sections, has a ratio of effective channel diameter to capillary channel length of less than 1:25. With such a design, the venting channel has a high flow resistance for liquids and gases and thereby reduces undesired outward flow of liquid constituents or gases, in particular of evaporated constituents of the medium, from the medium reservoir. Therefore, with or without the filter unit, an advantageous long-term stability of the medium contained in the medium reservoir can be ensured. In a preferred embodiment of the invention, the ratio between the effective channel diameter and the capillary channel length is less than 1:50, and, in a particularly preferred embodiment, less than 1:100. With a ratio of the effective channel diameter relative to the capillary channel length of 1:140, it is possible, at a normal pressure of 1013 hpa, a temperature of 40 degrees Celsius and a relative air humidity of 25 percent, to reduce an evaporation rate approximately by a factor of 10 from ca. 0.05 g per week to 0.005 g per week.

In another embodiment of the invention, the capillary channel has a helical configuration. This permits a particularly compact configuration of the capillary channel. The capillary channel can be provided on an inner face of a bore in one structural part and/or on an outer face of a structural part. The compact configuration permits integration of a capillary channel with a ratio according to the invention between effective channel diameter and capillary channel length, without this necessitating structural enlargement of the metering device equipped with the capillary channel.

In another embodiment of the invention, the capillary channel is designed as a circumferential helical groove between a cone surface and a cover, which has a cone-shaped recess adapted to the cone surface. This permits advantageous production of the capillary channel in an injection molding operation, because the cone-shaped geometry permits introduction of the helical groove of the capillary channel counter to the demolding direction of the structural part from the injection mold, thereby permitting a simple configuration of the injection mold. The capillary channel can be introduced into the cone surface and/or into the cone-shaped recess of the cover, and the advantageous means of production applies both to the cone surface and also to the recess in the cover.

In another embodiment of the invention, the capillary channel is formed between an outer surface of a cylinder arrangement and an inner surface of an attachment sleeve, several webs being provided on the outer surface of the cylinder arrangement and/or on the attachment sleeve, which webs are oriented substantially in the direction of a central longitudinal axis of the metering device and ensure a defined spacing of the attachment sleeve. The webs, which can in particular be arranged at a 120 degree offset on the cylinder arrangement and/or on the attachment sleeve, ensure that an interference fit or press fit can be obtained between the cylinder arrangement and the attachment sleeve. This allows the attachment sleeve to be pressed securely onto the cylinder arrangement, without this leading to undesired narrowing or deformation of the cylinder bore provided in the cylinder arrangement.

In another embodiment of the invention, the capillary channel is introduced as a groove in at least one of the webs. The web thus has a dual function as spacer and as capillary channel. The groove introduced into the web is closed by the structural part lying opposite it, that is to say by the attachment sleeve, in the case of a web assigned to the cylinder arrangement, or by the cylinder arrangement, in the case of a web provided in the attachment sleeve, and it thus forms the desired capillary channel. With the web oriented in the direction of the central longitudinal axis of the metering device, it is possible to produce the cylinder arrangement and the attachment sleeve easily in an injection molding operation.

In another embodiment of the invention, the capillary channel is made up of at least one annular portion and at least one channel portion that is oriented at least substantially along the central longitudinal axis of the metering device. By means of the annular portion, which can be arranged circumferentially about the central longitudinal axis, the channel portion arranged parallel to the central longitudinal axis is connected to the medium reservoir. The annular portion is part of the capillary channel and can be designed like the channel section between the cylinder arrangement and the attachment sleeve. The annular portion can in particular be embodied by two spaced-apart projections between the cylinder arrangement and the attachment sleeve, thereby permitting simple production of these structural parts by injection molding.

Further advantages and features of the invention will become clear from the claims and from the following description of preferred illustrative embodiments shown in the drawings, in which:

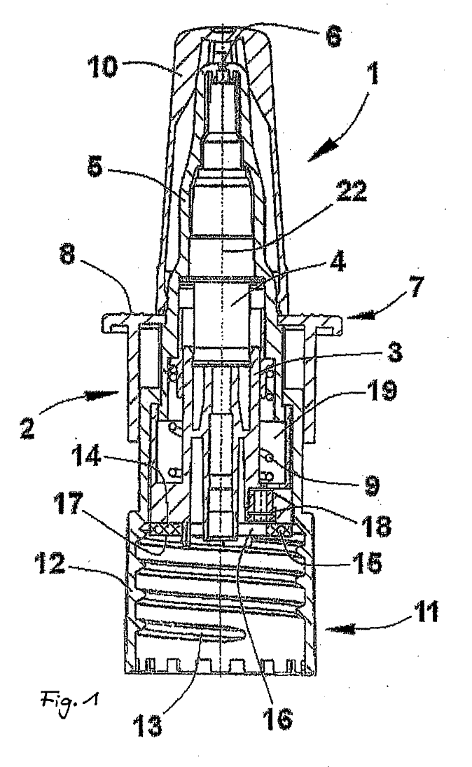

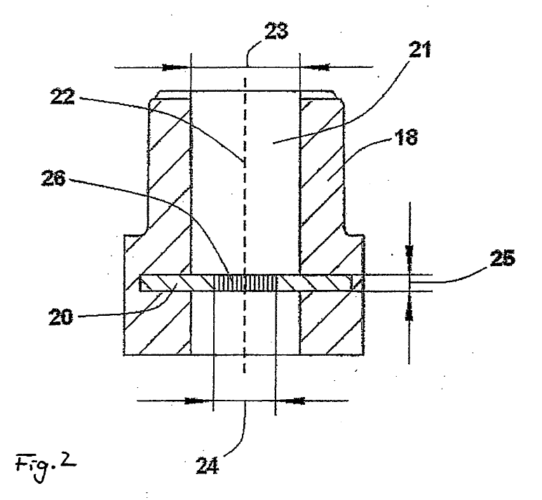

FIG. 1 shows a plane cross-sectional view of a metering device, with a filter cartridge provided in the venting device,

FIG. 2 shows a plane cross-sectional view of an enlarged detail of the filter cartridge according to FIG. 1,

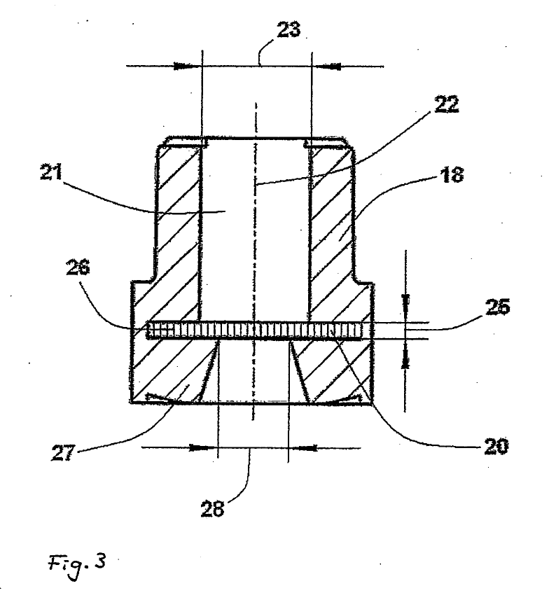

FIG. 3 shows a plane cross-sectional view of an enlarged detail of a second embodiment of a filter cartridge,

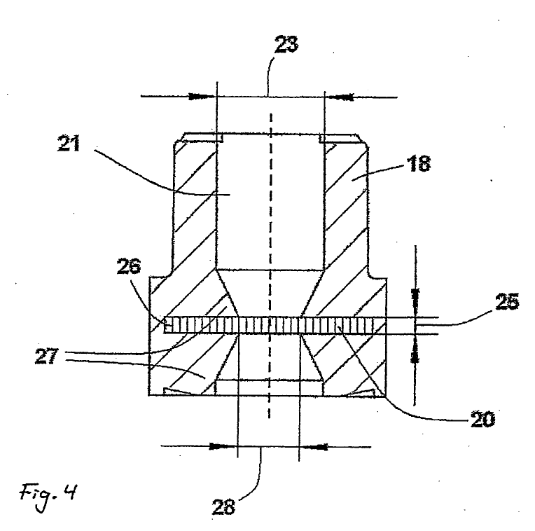

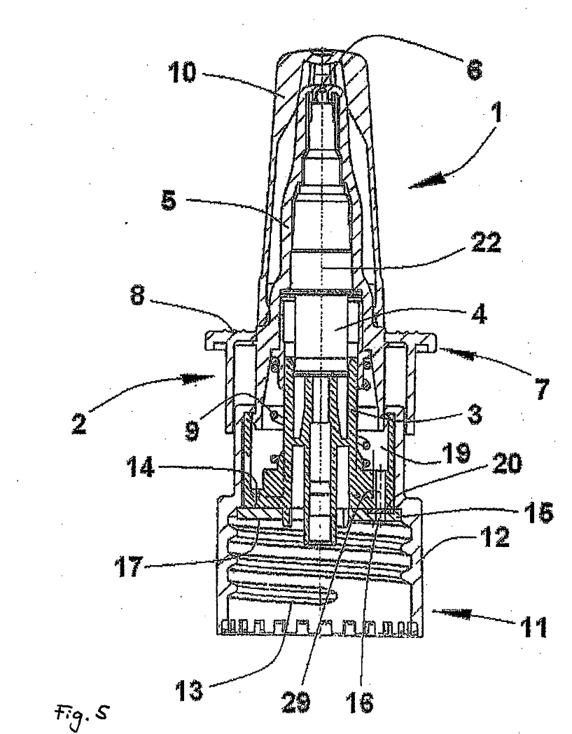

FIG. 4 shows a plane cross-sectional view of an enlarged detail of a third embodiment of a filter cartridge, and

FIG. 5 shows a plane cross-sectional view of a metering device with a flat seal with integrated filter unit,

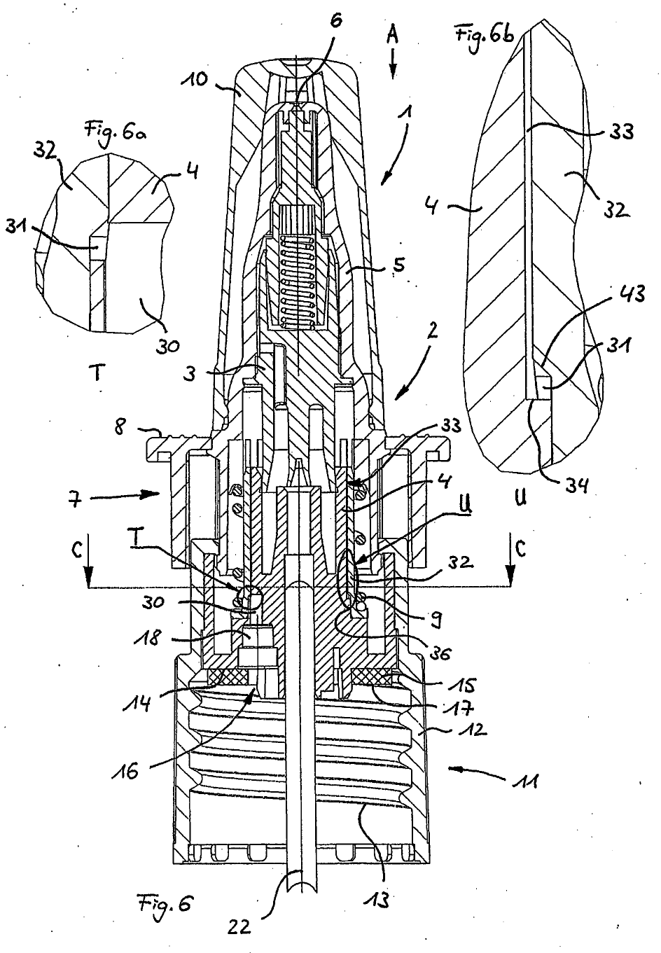

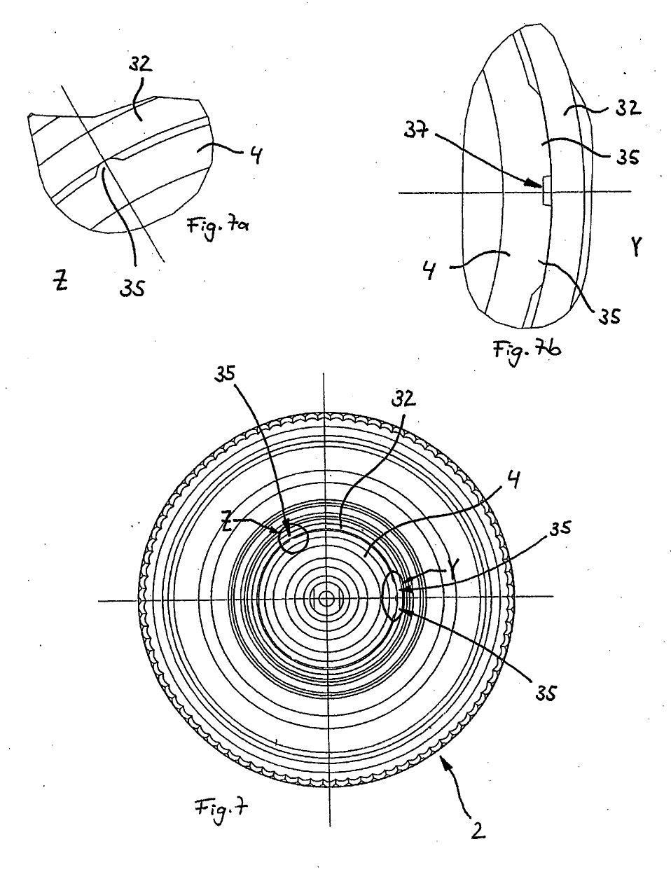

FIG. 6 shows a plane cross-sectional view of a metering device with a venting channel to which a filter unit is assigned, with a capillary channel coupled thereto,

FIG. 7 shows a plan view of the metering device according to FIG. 6, with the piston arrangement removed,

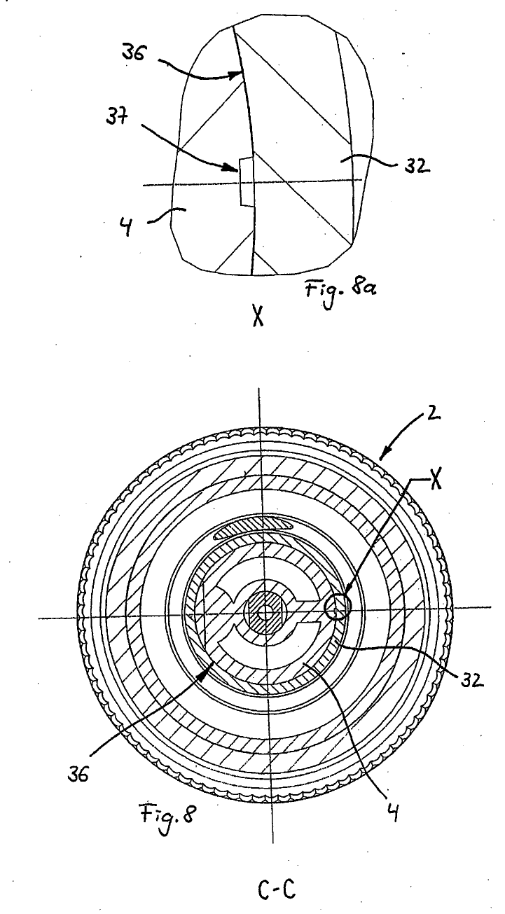

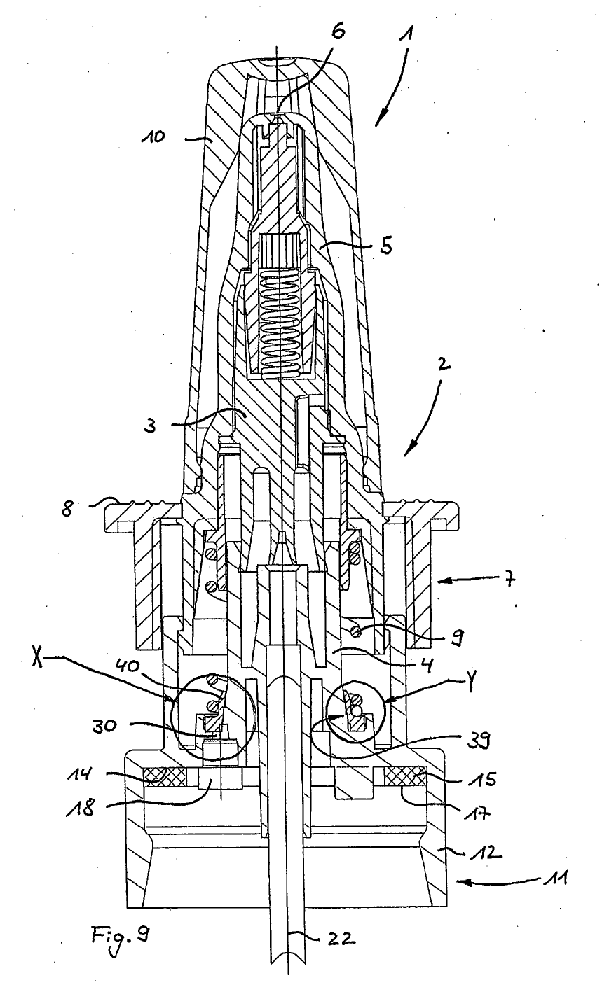

FIG. 8 shows a sectional view of the metering device according to FIG. 6,

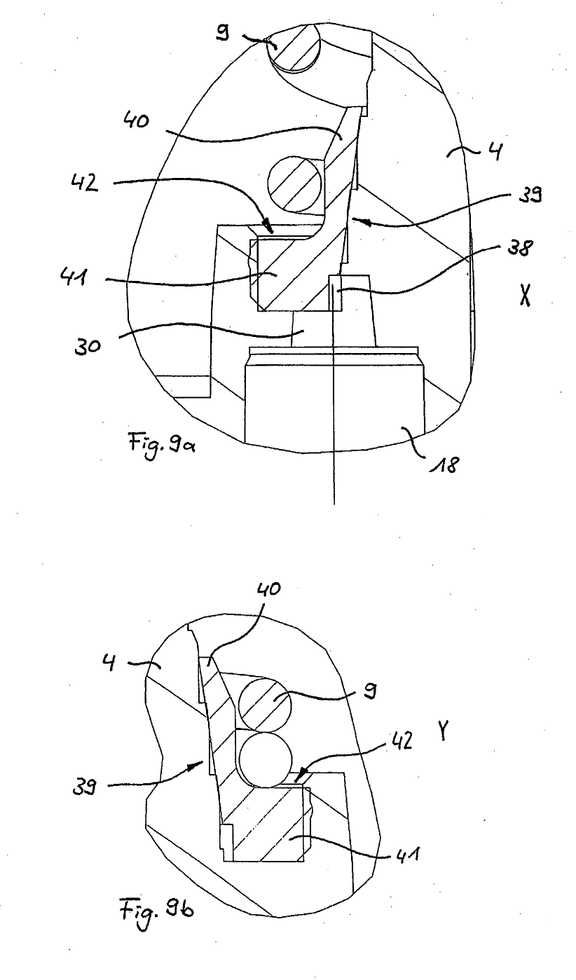

FIG. 9 shows a plane cross-sectional view of a metering device with a venting channel to which a filter unit is assigned, with a helically shaped capillary channel coupled thereto.

The metering device 1 according to FIG. 1 principally comprises a pump unit 2 which is intended to be mounted on a medium reservoir (not shown). The pump unit 2 comprises a schematically depicted piston arrangement 3, which is received in a likewise schematically depicted cylinder arrangement 4 and is intended to deliver a medium, contained in the medium reservoir, into an environment outside the metering device 1. The cylinder arrangement 4 is received in a substantially cone-shaped applicator 5 at whose narrowed end there is a discharge opening 6 through which the medium placed under pressure by the pump unit 2 can be discharged in finely atomized form to the environment. To initiate a relative movement, required for the discharge procedure, between the piston arrangement 3 and the cylinder arrangement 4, a handle 7 is provided that has finger rests 8. A user can thus actuate the metering device 1 by pressing it between thumb and index finger/middle finger, the thumb being placed against a base of the medium reservoir (not shown). To restore the piston arrangement 3 to the starting position according to FIG. 1, a restoring spring 9 is provided which, upon actuation of the metering device 1, applies a restoring force. The applicator 5 is provided with a protective cover 10, which is taken off for the discharging procedure.

An interface 11 for application of the medium reservoir is provided at an end of the pump unit 2 remote from the discharge opening 6. The interface 11 has a substantially cylindrically shaped outer sleeve 12 which receives the piston arrangement 3 and is operatively connected with a form fit to the applicator 5 in such a way that they are movable relative to one another. The outer sleeve 12 is provided with an inner thread 13 which is provided for form-fit engagement of an outer thread provided on the medium reservoir. Bearing on a circumferential end face 14 of the piston arrangement 3, there is a substantially circular flat seal 15 which is made of an elastic material and which ensures that a bottle neck provided on the medium reservoir is sealed off from the pump unit 2. The flat seal 15 has a venting aperture 16 which is provided as a connection via which the volume enclosed by the medium reservoir communicates with the environment. On a face directed toward the interface 11, the flat seal 15 has a sealing surface 17, which is provided for a sealing action with respect to the medium reservoir. A recess for form-fit engagement of a filter cartridge 18 is provided above the venting aperture 16, in the piston arrangement 3, said filter cartridge 18 being equipped with a filter membrane 20, shown in more detail in FIG. 2. The filter cartridge 18 is in communication with a hollow space 19, which is in turn connected to the environment via slits (not shown) in the metering device 1. In this way, gas molecules are allowed to flow into and out of the medium reservoir. The venting aperture 16, the filter cartridge 18 and the hollow space 19 thus form the venting device of the metering device 1. A stream of gas emerging from the medium reservoir, for example a stream of evaporated constituents of the medium, must by necessity flow through the venting device in order to escape into the environment. The same applies to the reverse scenario, namely where gas is sucked from the environment into the medium reservoir. In this case too, it has to flow entirely through the venting device.

In the enlarged details shown in FIGS. 2 to 4, the same reference numbers are used as in FIG. 1 for components having the same function.

The filter cartridge 18, shown in more detail in FIG. 2, comprises a filter membrane 20, which is designed as a microbe barrier and is received in a through-bore 21 of the filter cartridge 18. A longitudinal axis 22 of the through-bore 21 is oriented parallel to a longitudinal axis of the metering device 1. The filter membrane 20 is intended to ensure that contaminants from the environment cannot get into the medium reservoir (not shown). The through-bore 21 has an internal diameter 23 that is at least approximately constant along the entire length of the filter cartridge 18. The filter membrane 20 is injected with a form fit into the filter cartridge 18, designed as a plastic injection-molded part, and is delimited by the through-bore 21. The effective surface area of the filter membrane 20 is defined by the effective diameter 24, which is smaller than the internal diameter 23. It is only within the effective surface area of the filter membrane 20 that pores or channels 26 are provided which allow gas molecules to pass through, whereas no pores or channels are provided outside of the effective surface area. The channels 26 provided in the filter membrane 20 are depicted only schematically. Depending on the method used for producing the filter membrane 20, they can also adopt a curved profile and can have different cross sections along their course. The channels 26 can be generated before or after the injection into the filter cartridge 18, and in particular by bombarding the filter membrane with high-energy electromagnetic radiation. A decisive factor for the passage of gas molecules is represented by the minimum free cross section of the channels 26, since this limits the size of the gas molecules that can pass through the channels. The diffusion coefficient of the filter membrane 20 is additionally defined by the thickness 25 of the filter membrane 20, where a greater thickness 25 leads to a reduction in the diffusion coefficient, since the passage of gas molecules is made difficult by the increased length of the channels 26 and also by the greater thickness of the base material. In the case of the filter cartridge 18 shown, the internal diameter 23 of the through-bore 21 is ca. 1.4 mm, the effective diameter 24 by contrast is ca. 0.9 mm, such that the effective surface area is ca. 0.65 mm².

In a filter cartridge 18 according to FIG. 2, a filter membrane 20 can be provided that is made from the material polyethyleneterephthalate (PET, PEPT). This filter membrane 20 has a pore size of 0.2/1000 mm (0.2 μm) with a membrane thickness of 36/1000 mm (36 μm) and an effective filter surface area of less than 0.8 mm². Therefore, if a measurement of evaporation rate is carried out at a normal pressure of 1013 hPa, a temperature of 40 degrees Celsius and an air humidity of 25 percent, this results in an evaporation rate of approximately 0.033 g per week for the filter cartridge 18 when used in the metering device 1 shown in FIG. 1. That is to say, approximately 0.03 gram of liquid escapes from the medium reservoir per week. This represents a reduction in evaporation rate of ca. 30 percent compared to known metering devices equipped with conventional filters. By varying the pore size, the density of the pores on the surface of the filter membrane, the thickness of the filter membrane and the effective filter surface area, it is possible for the evaporation rate to be reduced by at least 15%, preferably by 30%, particularly preferably by 50%.

Compared to the filter cartridge shown in FIG. 2, the filter cartridge 18 shown in FIG. 3 is equipped with a filter membrane 20 which, across its entire surface, has a substantially constant number of channels 26 per unit of area. A reduction in the diffusion rate is achieved by the fact that, on one side, a conical flow-guide geometry 27 is provided which reaches as far as the filter membrane and which leads to a reduction in the effective surface area. Accordingly, the effective surface area is defined by the minimal diameter 28 of the flow-guide geometry 27 and amounts, for example, to ca. 0.65 mm², while the internal diameter 23 of the through-bore 21 is ca. 1.4 mm. The filter membrane 20 can be cut out from a homogeneous material blank permeated uniformly by channels 26, and it can be introduced into the filter cartridge 18 by plastic injection molding.

In the filter cartridge 18 shown in FIG. 4, in contrast to the filter cartridge known from FIG. 3, a flow-guide geometry 27 is provided on both sides of the filter membrane 20. The effective surface area is defined by the minimal diameter 28 of the flow-guide geometry 27, and the filter membrane 20, as in the embodiment according to FIG. 3, is designed as a homogeneous membrane uniformly permeated by channels 26. By means of the flow-guide geometries 27 being arranged on both sides, particularly advantageous stabilizing of the filter membrane 20 is achieved, and, in addition, the conical configuration of the flow-guide geometries 27 can ensure an advantageous flow behavior of the gas stream that passes through the filter membrane. As regards the internal diameter 23 of the through-bore 21 and the minimal diameter 28, the same dimensions apply as those given for the filter cartridge in FIG. 3.

In a filter cartridge 18 according to FIG. 3 or FIG. 4, a filter membrane 20 made of polytetrafluoroethylene (PTFE) can be provided. A filter membrane 20 of this kind has a pore size of 0.2/1000 mm (0.2 μm) and is applied to a carrier membrane of PET, thus giving a total membrane thickness of approximately 0.2 mm. The effective surface area is limited by the flow-guide geometries 27 to approximately 0.5 mm², such that, when the evaporation rate is determined at a normal pressure of 1013 hPa, a temperature of 40 degrees Celsius and an air humidity of 25 percent, the filter cartridge 18 is found to have an evaporation rate of approximately 0.033 g per week when used in the metering device 1 shown in FIG. 1. This represents an approximately 30 percent reduction in the evaporation rate compared to known metering devices equipped with conventional filters.

In the embodiment of the invention shown in FIG. 5, which corresponds to the metering device of FIG. 1 in terms of its basic structure, the filter membrane 20 is provided in a depression in the flat seal 15 and closes off a venting aperture 16, which is part of the venting device. A venting channel 29 is operatively connected to the filter membrane 20 and allows gas molecules to flow into and out of the hollow space 19. As in the embodiments in FIGS. 3 and 4, the effective surface area of the filter membrane 20 is determined by the minimal diameter of the venting aperture 16, while the filter membrane is permeated by a homogenous number of channels per unit of area.

In an embodiment of the invention not shown here, the filter membrane 20 is applied, in particular laminated, onto a surface of the flat seal 15.

In another embodiment, the filter membrane, in the area of the venting aperture 29 of the piston/cylinder arrangement 3 in FIG. 5, is applied, in particular welded or laminated, from above or below onto a corresponding surface of the piston/cylinder arrangement 3.

In the embodiments of the metering device that are provided with capillary channels, as shown in FIGS. 6 to 9, the same reference numbers that were used for the metering devices according to FIGS. 1 to 5 are again used here for structural parts that have the same function.

The metering device 1 shown in FIGS. 6, 7 and 8 comprises a filter cartridge 18 which is provided on the cylinder arrangement 4 and which can be configured as in the embodiments in FIGS. 1 to 5. On an end of the filter cartridge 18 directed away from the medium reservoir, the through-bore 21 opens into a distributor bore 30 which, via an outlet opening 38, communicates with a circumferential annular portion designed as annular channel 31, as is shown in more detail in FIG. 6a. The annular channel 31, which is formed between the cylinder arrangement 4 and an attachment sleeve 32 fitted thereon, opens into a channel portion 33 of the capillary channel oriented in the direction of the longitudinal axis of the metering device 1, as is shown in more detail in FIG. 6b. The annular channel 31 is formed by a circumferential step 34 on the cylinder arrangement 4 and by a correspondingly shaped step 43 on the attachment sleeve 32 and, being configured as a long channel of narrow cross section, is a part of the capillary channel.

As is shown in FIG. 7, the channel portion 33 is formed by a groove 37 in a support web 35 and by the attachment sleeve 32 lying opposite the support web 35. A further function of the support webs 35 is that of permitting a force-fit engagement of the attachment sleeve 32 on the cylinder arrangement 4, without the cylinder bore in the cylinder arrangement 4 being deformed by the attachment sleeve 32. To ensure a defined geometry of the capillary channel, a circumferential collar 36 is provided above the mouth of the distributor bore 30 and, as is shown in more detail in FIG. 8, ensures that the attachment sleeve 32 is received in a leaktight manner in an end area directed toward the medium reservoir. The circumferential collar 36 is provided only with the groove 37 which is shown in FIG. 8a and which forms the channel portion 33. In the embodiment shown in FIGS. 6 to 8, the capillary channel has a length of approximately 60 mm and has an effective capillary channel diameter of ca. 0.42 mm, thus giving a ratio of effective capillary channel diameter to capillary channel length of 1:140. With such a ratio, an evaporation rate of approximately 0.005 g per week can be achieved, determined at normal pressure of 1013 hPa, a temperature of 40 degrees Celsius and an air humidity of 25 percent.

In the embodiment according to FIG. 9, the capillary channel is designed as a helical groove between a cone exterior surface 39 and a cover 40. The cover 40 has a cone-shaped recess and is pressed with an annular collar 41 into a retaining groove 42, as is shown in more detail in FIGS. 9a and 9b. The passage of the cylinder arrangement 4 through the cover 40 shows that an interference fit, also designated as a press fit, is provided between these structural parts in order to ensure a secure seat of the cover 40 and a good sealing of the capillary channel. The cone exterior surface 39 is a component part of the cylinder arrangement 4 and has a spiral-shaped and helical circumferential shoulder designed in the manner of a conical worm. Such a configuration of the cone exterior surface 39 ensures that the cylinder arrangement 4 can be produced as a plastic injection-molded part, since the orientation of the surfaces at the ends permits demolding from the plastic injection-molding tool without a slide or other complex die parts. As is shown in more detail in FIG. 9a, the distributor bore communicating with the filter cartridge 18 opens via an outlet opening 38 into the capillary channel, which is formed by the cone exterior 39 and the cover 40. The cover 40 additionally serves as a support surface for the restoring spring 9.

In an embodiment not shown here, the filter membrane is accommodated in a depression in the flat seal, as has been indicated in FIG. 5, and is coupled to a capillary, in accordance with one of to FIGS. 6 to 9, as a result of which a metering device can be obtained that has a simple structure and is characterized by a very low evaporation rate.

1. A metering device for at least one medium, with a pump unit, which is operatively connected to a medium reservoir for the purpose of discharging said medium, and with a venting device which is assigned to at least one of the medium reservoir and the pump unit and which has a venting channel to which a filter membrane is assigned, wherein the filter membrane is configured for a reduced diffusion rate.

2. The metering device as claimed in claim 1, wherein the filter membrane has a reduced effective cross section compared to known filter membranes.

3. The metering device as claimed in claim 2, wherein the reduced effective cross section of the filter membrane is achieved by a reduced effective surface area compared to known filter membranes.

4. The metering device as claimed in claim 3, wherein the effective surface area of the filter membrane is limited by a flow-guide geometry which, at least in some sections, has a conical design.

5. The metering device as claimed in claim 3, wherein the effective surface area of the filter membrane is smaller than 1.4 mm².

6. The metering device as claimed in claim 2, wherein, in order to obtain the reduced effective cross section, a mean free cross section of pores in the filter membrane is designed smaller than in known filter membranes.

7. The metering device as claimed in claim 2, wherein, in order to obtain a reduced effective cross section, a reduced number of pores is provided compared to known filter membranes.

8. The metering device as claimed in claim 7, wherein the filter membrane has a mean number of pores of less than 1 million pores per mm².

9. The metering device as claimed in claim 1, wherein the filter membrane is provided on a sealing unit which is arranged in the venting channel and which is located in particular between the medium reservoir and the pump unit.

10. The metering device as claimed in claim 9, wherein the filter membrane is designed to close a through-opening which is provided in the sealing unit and which is assigned to the venting channel.

11. The metering device as claimed in claim 1, wherein the filter membrane is applied, in particular laminated on, in the area of a venting aperture of at least one of the medium reservoir and the pump unit.

12. The metering device as claimed in claim 1, wherein the filter membrane is designed as a discrete filter cartridge.

13. A metering device for at least one medium, with a pump unit, which is operatively connected to a medium reservoir for the purpose of discharging said medium, and with a venting device which is assigned to at least one of the medium reservoir and the pump unit and which has a venting channel to which a filter membrane is assigned, wherein the venting channel is designed at least in some sections as a capillary channel which, at least in some sections, has a ratio between effective channel diameter (d) and capillary channel length (l) of less than 1:25.

14. The metering device as claimed in claim 13, wherein the capillary channel has a helical configuration.

15. The metering device as claimed in claim 14, wherein the capillary channel is designed as a circumferential helical groove between a cone exterior surface and a cover, which has a cone-shaped recess adapted to the cone exterior surface.

16. The metering device as claimed in claim 13, wherein the capillary channel is formed between an outer surface of a cylinder arrangement and an inner surface of an attachment sleeve, several webs being provided on the outer surface of the cylinder arrangement and/or on the attachment sleeve, which webs are oriented substantially in the direction of a central longitudinal axis of the metering device and ensure that the attachment sleeve is held at a defined distance.

17. The metering device as claimed in claim 16, wherein the capillary channel, in some sections, is formed as a groove in at least one of the webs.

18. The metering device as claimed in claim 17, wherein the capillary channel is composed of at least one annular portion, and of at least one channel portion that is oriented at least substantially along the central longitudinal axis of the metering device.

19. The metering device of claim 5, wherein the effective surface area of the filter membrane is smaller than 0.6 mm².

20. The metering device of claim 19, wherein the effective surface area of the filter membrane is smaller than 0.2 mm².

21. The metering device of claim 13, wherein the ratio between effective channel diameter (d) and capillary channel length (l) is less than 1:50.

22. The metering device of claim 21, wherein the ratio between effective channel diameter (d) and capillary channel length (l) is less than 1:100.

23. The metering device of claim 8, wherein the filter membrane has a mean number of pores of less than 600,000 pores per mm².

24. The metering device of claim 23, wherein the filter membrane has a mean number of pores of less than 300,000 pores per mm².
